(19) United States
(12) Patent Application Publication
(10) Pub. No.: US 2013/0252117 A1
(43) Pub. Date: Sep. 26, 2013

(54) APPARATUS AND METHOD FOR HUMIDIFIED FLUID STREAM DELIVERY TO FUEL CELL STACK

(71) Applicants: Milos Milacic, New Boston, MI (US); Falko Berg, Plymouth, MI (US)

(72) Inventors: Milos Milacic, New Boston, MI (US); Falko Berg, Plymouth, MI (US)

(73) Assignee: FORD GLOBAL TECHNOLOGIES, LLC, Dearborn, MI (US)

(21) Appl. No.: 13/428,299

(22) Filed: Mar. 23, 2012

(51) Int. Cl. H01M 8/06

(52) U.S. Cl. 429/413

(57) ABSTRACT

An apparatus for providing a humidified cathode fluid stream to a fuel cell stack is disclosed. The apparatus comprising a first humidifier including membranes and a compressor. The first humidifier is configured to receive a cathode fluid stream and to humidify the cathode fluid stream with water from a recirculated fluid stream to provide a first humidified cathode stream. The compressor is configured to receive the first humidified cathode stream and to provide a first pressurized humidified cathode stream. The compressor is further configured to generate a pressure differential across the first humidifier such that the membranes are humidified with the water.

### TECHNICAL FIELD

Embodiments disclosed herein generally relate to an apparatus and method for humidified fluid stream delivery to a fuel cell stack.

### BACKGROUND

It is generally known that a number of fuel cells are joined together to form a fuel cell stack. Such a stack generally provides electrical current in response to electrochemically converting hydrogen and oxygen into water and energy. The electrical current is used to provide power for various electrical devices in the vehicle or in other suitable mechanisms.

An inherent deficiency of a fuel cell membrane is that the membrane requires humidification to operate properly. Due to such a condition, an additional subsystem is needed to adequately humidify the membrane. During operation of the fuel cell in an automotive environment, the fuel cell operates at lower powers (i.e., current densities), leading to increased humidification demand since not enough product water is being generated.

Conventional systems deliver water in the air and hydrogen streams that are fed to the fuel cell stack to ensure that such membranes are kept moist. While it may be necessary to ensure that membranes are kept moist, one consideration should account for not providing too much water in the air and hydrogen streams since such excess water may clog membranes in the fuel cell and lead to inefficient operation of the fuel cell stack.

One example of humidifying an air stream in connection with a fuel cell is set forth below.

Japanese Patent Publication No. JP20100198743 to Toshikatsu et al. discloses a fuel cell system that includes a fuel cell in which oxidant gas and fuel gas are supplied. The fuel cell generates power by electro-chemical reaction of these oxidant gas and fuel gas. The fuel cell system further includes a humidifier that transfers moisture contained in the oxidant gas discharged from the fuel cell to the oxidant gas to be supplied to the fuel cell and a compressor that compresses the oxidant gas humidified by the humidifier and sends to the fuel cell. The fuel cell system further includes condensing means that condenses power generation produced water discharged from the fuel cell and stores it. The condensed water stored by the condensing means is supplied to the spacing between the humidifier and the compressor upstream of the fuel cell.

### SUMMARY

An apparatus for providing a humidified cathode fluid stream to a fuel cell stack is disclosed. The apparatus comprising a first humidifier including membranes and a compressor. The first humidifier is configured to receive a cathode fluid stream and to humidify the cathode fluid stream with water from a recirculated fluid stream to provide a first humidified cathode stream. The compressor is configured to receive the first humidified cathode stream and to provide a first pressurized humidified cathode stream. The compressor is further configured to generate a pressure differential across the first humidifier such that the membranes are humidified with the water.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts an apparatus for humidifying a fluid stream that is passed to a fuel cell stack in accordance to one embodiment;

FIG. 2 depicts the manner in which more water may be driven across membranes of a first humidifier in accordance to one embodiment; and

FIG. 3 depicts an apparatus for humidifying a fluid stream that is passed to the fuel cell stack in accordance to another embodiment.

### DETAILED DESCRIPTION

As required, detailed embodiments of the present disclosures are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Fuel cell technology has been well acknowledged to offer the promise of generating clean and efficient power for stationary, portable and transportation applications. The proton exchange membrane fuel cell (PEMFC) is attractive for vehicle applications, relative to other fuel cell designs, due to its higher power density and lower temperature of operation. Conventional PEMFCs separate the electrochemical reactions that generate electricity, as well as the gas reactants, with the proton exchange membrane (PEM) itself. While PEMs allow the transport of protons from an anode to a cathode, PEM fuel cells generally need both moisture content in the proton exchange membrane and sufficient moisture in the anode fuel stream to provide water to the protons to enable the transport. Humidified fuel and air streams are commonly used to provide the needed moisture to assure the function. One method of humidifying the reagent streams is by utilizing a gas to gas (“G2G”) humidifier. There are a number of G2G humidifying devices and a large number of such G2G humidifiers comprise numerous layers (or membranes) or numerous thin tubes in order to obtain adequate surface to produce the desired humidifying effect.

Although G2G humidifiers have been proven in fuel cell applications as a simple, robust and reliable way to humidify air stream, their size (and efficiency) represent an ongoing consideration. For example, a G2G humidifier for a 90 kW system may be as large as 42 liters in volume. Additionally, G2G humidifiers generally include membranes and an intercooler may be needed in order to avoid melting of the membranes in the G2G humidifier. If G2G humidifer membranes can withstand higher temperatures, then the intercooler may be down sized or simply removed.

Various fuel cell systems implementations as disclosed herein contemplate positioning the G2G humidifier before a compressor. In this implementation, an air stream is provided to the compressor, which then increases the pressure of the air stream for delivery to the fuel cell stack. By positioning the G2G humidifier before the compressor while delivering the air stream to the fuel cell stack, it is possible to take advantage of the lower pressure on a dry side of the G2G humidifier to drive more water across membranes (e.g., in the G2G humidifier) to humidify the incoming air stream that is delivered to the a fuel cell stack. For example, a higher pressure differential across the membrane of the G2G humidifier enables more water (i.e., more humidity) to pass through the membranes thereby causing the air stream to achieve optimal humidity levels. Such a condition may enable the size/area of the G2G humidifier to be reduced. A reduction in size/area of the G2G humidifier may reduce cost/complexity.

In addition, by humidifying the air stream via the G2G humidifier that is positioned prior to the compressor, the output air stream from the compressor may be cooler thus allowing for a reduction in size of an intercooler of simply eliminating the need for the intercooler. This condition may obviate the need for a full size intercooler in the fuel cell system, which further reduces the cost/complexity of the fuel cell system. Generally, intercoolers are needed to cool the incoming air stream to prevent membranes within the G2G humidifier from melting. It is recognized that the compressor may output the air stream at a higher temperature. However, by positioning the G2G humidifier prior to the compressor, more energy is needed in order to heat the water in the air stream therefore causing the overall mixture of water and air to exhibit a lower temperature. Such a condition may be attributed to the G2G humidifier lowering the temperature of dry gas (i.e., supply air) entering into the G2G humidifier due to condensation, evaporation, and other factors. While the temperature of the dry gas may increase, such a temperature increase may not rise to the level as that expected by a pure “temperature exchange.” As such, the temperature may be lower than usual and it may be necessary to expend more energy to heat the water in the air stream.

In yet another implementation as disclosed herein, multiple G2G humidifiers may be provided such that water discharged from a stack outlet of the fuel cell stack is provided to the G2G humidifiers to humidify the air stream both pre and post compressor streams. A small intercooler may be needed depending on the types of material(s) that are used for the membranes of the G2G humidifier(s) for the various implementations disclosed herein. Similar to the implementation noted above, this implementation also takes advantage of the higher-pressure differential across the membranes of the G2G humidifier thereby causing more water to pass through the membranes, which results in an increase in humidity levels within the air stream.

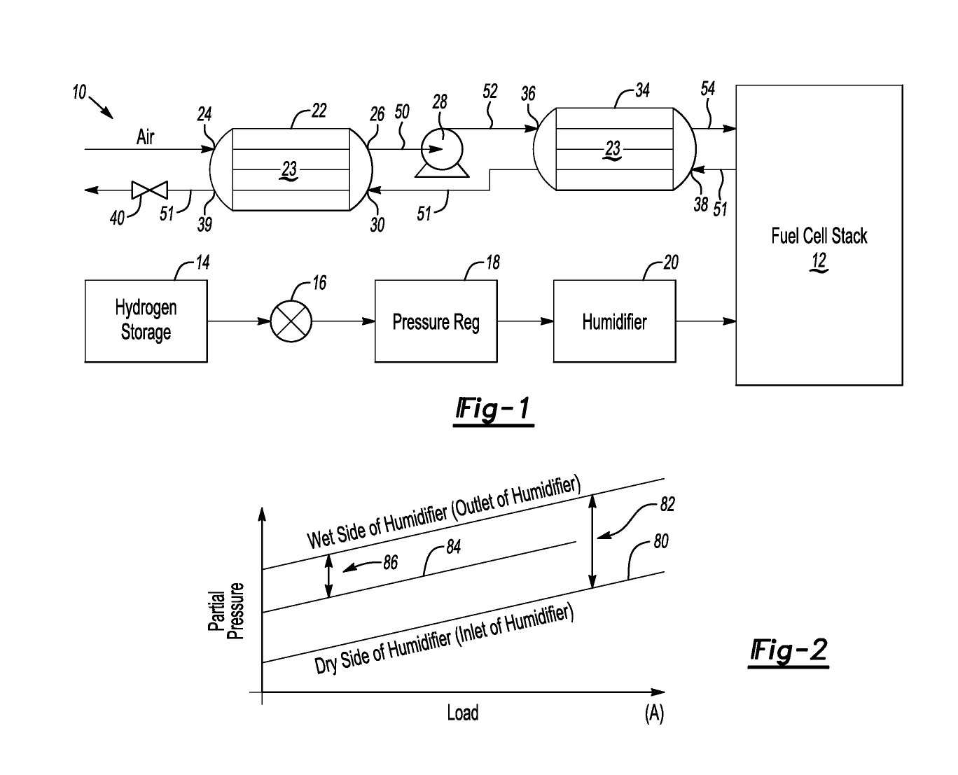

FIG. 1 depicts an apparatus 10 for humidifying a fluid stream that is passed to a fuel cell stack 12 in accordance to one embodiment. The fuel cell stack 12 is configured to generate electrical current for powering one or more various devices (not shown) in a vehicle (or other apparatus) in response to electrochemically converting hydrogen and oxygen into water and energy. The electrical current is used to provide power for various electrical devices in the vehicle (or other apparatus). It is recognized that the apparatus 10 and the fuel cell stack 12 may be implemented in any application in which it is desired to generate electrical current through the use of electrochemically converting hydrogen and oxygen.

A tank (or supply) 14 provides a supply fuel stream (or an anode stream) in the form of hydrogen. The supply fuel stream comprises compressed hydrogen. While compressed hydrogen may be used in the apparatus 10, any hydrogen fuel source may be implemented in the apparatus 10. For example, liquid hydrogen, hydrogen stored in various chemicals such as sodium borohydride or alanates, or hydrogen stored in metal hydrids may be used instead of compressed gas.

A tank valve 16 controls the flow of the supply hydrogen. A pressure regulator 18 regulates the flow of the supply hydrogen to the fuel cell stack 12. A humidifier 20 may be optionally provided to add water into the input fuel stream for generating a humidified input fuel stream. Water vapor in the humidified input fuel stream may be needed to ensure that membranes in the fuel cell stack 12 remain humidified to provide for optimal operation of the fuel cell stack 12. It is recognized that a recirculated hydrogen stream may be provided from an outlet of the fuel cell stack 12 in lieu of, or in combination with the humidifier 20 to humidify the input fuel stream to generate the humidified input fuel stream. For example, the recirculated hydrogen (or anode) stream may be delivered to the input fuel stream to humidify the same for providing the humidified fuel stream.

A first fluid stream (or cathode stream) which comprises dry air is fed to a first humidifier 22. A compressor 28 and a second humidifier 34 are in fluid communication with the first humidifier 22 and the fuel cell stack 12. The first humidifier 22 and the second humidifier 34 may each be implemented as a G2G humidifier or other suitable device. An example of a G2G humidifier is set forth in U.S. Pat. No. 8,003,265, entitled “Gas Conditioning Device and Method” filed on May 11, 2006 to Schank et al., which is hereby incorporated by reference in its entirety.

The first humidifier 22 includes a first inlet 24 (or dry gas inlet) for receiving the dry air. The first humidifier 22 adds water to the cathode stream to humidify the same. The first humidifier 22 includes a second inlet 30 (or wet gas inlet) for receiving water that is recirculated, or recirculate water 51 (e.g., product water) from the fuel cell stack 12 and passed through the second humidifier 34 (and/or passed through the first humidifier 22) in response to electrochemically converting the air and the hydrogen (e.g., generating electrical power). Water in the cathode stream may be needed to ensure that membranes (not shown) in the fuel cell stack 12 remain moist to provide for optimal operation of the fuel cell stack 12.

A first outlet 26 of the first humidifier 22 provides a humidified cathode stream 50. The compressor 28 receives the humidified cathode stream 50 and increases the pressure of the same to provide a first pressurized humidified cathode stream 52. The first humidifier 22 and the second humidifier 34 each generally include a plurality of membranes 23. Such membranes 23 may be formed of GORE-TEX®, Nafion® or other suitable materials. The membranes 23 generally define dry air channels and at least one wet channel. Water that is provided by the fuel cell stack 12 and the second humidifier 34 flows into the wet gas inlet 30 of the first humidifier 22. Air that enters into the first humidifier 22 is humidified as the water passes from the wet channel and into the dry air channels thereof. By positioning the compressor 28 after the first humidifier 22, it is recognized that more water can be driven across the membranes 23 of the first humidifier 22. Such a condition may reduce the overall size of the membranes 23 and consequently the size of the first humidifier 22 thereby reducing cost.

FIG. 2 generally depicts the manner in which more water may be driven across the membranes 23 of the first humidifier 22. As shown, in moments in which a lower partial pressure (or low partial pressure) is exhibited (see 80) (e.g., prior to the compressor 28), more water is driven across the membranes 23 of the first humidifier 22 because of a higher pressure differential, which enables the air to absorb more water (see 82 which is indicative of more water being driven through the membranes of the first humidifier 22). As shown at 84, when an increase in partial pressure (or increased partial pressure) is exhibited, less water is driven through the membranes 23 of the first humidifier 22 (see 86 which is indicative of less water being driven through the membranes 23 of the first humidifier 22). The compressor 28 creates the high pressure differential thereby allowing more water to pass to the membranes 23. The high pressure differential is generated because the partial pressure on the wet side of the first humidifier 22 (e.g., at the first outlet 26) is high and the partial pressure on the dry side of the first humidifier 22 (e.g., at the first inlet 24) is low.

Referring back to FIG. 1, the compressor 28 pressurizes the humidified cathode stream 50 and delivers the first pressurized humidified cathode stream 52 to the second humidifier 34. The second humidifier 34 includes a gas inlet 36 and a wet gas inlet 38. The fuel cell stack 12 provides water (or the recirculated water 51) to the wet gas inlet 38. The second humidifier 34 receives the first pressurized humidified cathode stream 52 to add more water into the same. The second humidifier 34 adds more water into the first pressurized humidified cathode stream 52 to provide a final pressurized humidified cathode stream 54 to the fuel cell stack 12.

The first pressurized humidified cathode stream 52 is generally at a higher temperature than the temperature of the humidified cathode stream 50 after being pressurized by the compressor 28. Because the first pressurized humidified cathode stream 52 is at a higher temperature than that of the humidified cathode stream 50, the first pressurized humidified cathode stream 52 is capable of storing more water. To take advantage of such a condition, the second humidifier 34 is provided to add more water into the first pressurized humidified cathode stream 52 to provide the final pressurized humidified cathode stream 54. This is done prior to ensure that the membranes of the fuel cell stack 12 are kept humidified. It is recognized that the size of the first humidifier 22 and the second humidifier 34 may be similar to or different from one another. The second humidifier 34 provides the final pressurized humidified cathode stream 54 that is delivered to the fuel cell stack 12.

An exhaust valve 40 is fluidly coupled to an outlet 39 of the first humidifier 22. The outlet 39 delivers water (or the recirculated water 51) from the first humidifier 22 to the valve 40. The valve 40 may be controlled by a controller (not shown) to regulate pressure (or flow) on the cathode side of the fuel cell stack 12. Various humidity sensors (not shown) may be positioned along the cathode side to monitor the humidity of the cathode stream as it passes through the first humidifier 22 and the second humidifier 34. Depending on the design, the compressor 28 controls the pressure of the cathode fluid stream while the valve 40 controls the flow of the cathode fluid stream in the apparatus 10 (e.g., in the case of a centrifugal compressor). Or, alternatively, the compressor (if a positive displacement device) controls the flow on the cathode, while the valve 40 adjust the pressure of the cathode fluid.

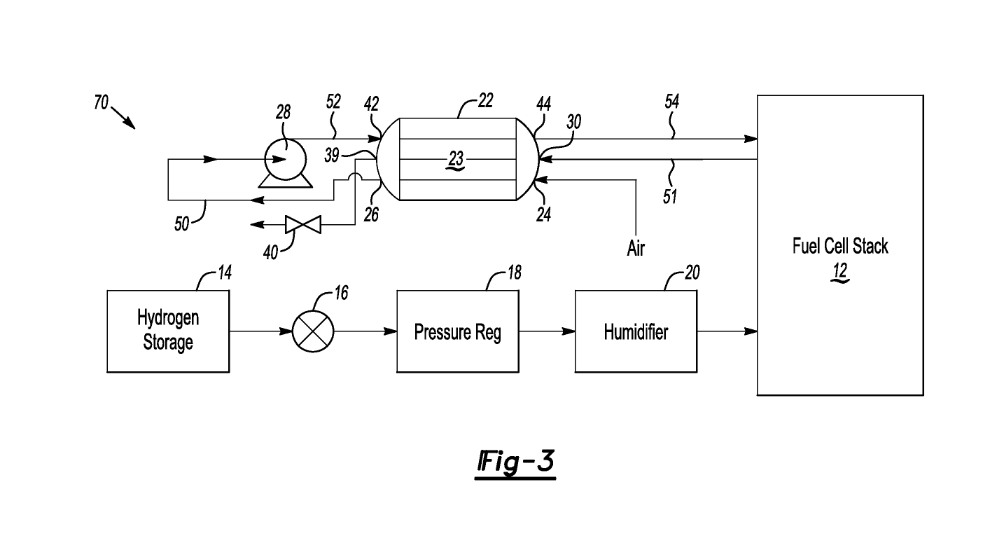

FIG. 3 depicts an apparatus 70 for humidifying a fluid stream that is passed to the fuel cell stack 12 in accordance to another embodiment. Operation of the manner in which the humidified input fuel stream is provided to the fuel cell stack 12 is similar to that described above in connection with FIG. 1. Operation of the manner in which the final pressurized humidified cathode stream 54 is provided to the fuel cell stack 12 is different than that described in connection with FIG. 1. For example, the apparatus 70 utilizes a single G2G humidifier arrangement (or the first humidifier 22) for providing the final pressurized humidified cathode stream 54 to the fuel cell stack 12 as opposed to a multi-G2G humidifier arrangement.

Dry air is delivered to the first humidifier 22 to the dry air inlet 24 and the recirculated water 51 is delivered to the first humidifier 22 at the wet gas inlet 30 from the fuel cell stack 12. The first humidifier 22 adds water to the dry air in a similar manner to that described above in connection with FIG. 1. For example, the dry air that enters into the first humidifier 22 is humidified as the water passes from the wet channel and into the dry air channels (e.g., where the dry air flows) as defined by the membranes 23 of the first humidifier 22. The compressor 28 receives the humidified cathode stream 50 from the first outlet 26 of the first humidifier 22 and provides the first pressurized humidified cathode stream 52. The first humidifier 22 provides more water into the humidified cathode stream 50 due to the high pressure differential that is present between the pressure of the dry air as it enters into the first inlet 24 of the first humidifier 22 and the pressure of the wet air as it exits from the first outlet 26 of the first humidifier 22. As noted above, in connection with FIG. 2, the high pressure differential enables more water to flow through the membranes 23 of the first humidifier 22 and into the dry air thereby providing for a decrease in the size of the first humidifier 22. The positioning of the first humidifier 22 prior to the compressor 28, enables the compressor 28 to generate the high pressure differential within the first humidifier 22 to adequately humidify the membranes 23 therein.

An outlet of the compressor 28 provides the first pressurized humidified cathode stream 52 where it is delivered to back to an inlet 42 of the first humidifier 22. The compressor 28 provides the first pressurized humidified cathode stream 52 back to the first humidifier 22 at a temperature that is greater than the temperature of the humidified cathode stream 50 that is received from the first outlet 26 of the first humidifier 22. Since the first pressurized humidified cathode stream 52 is hotter after it is passed through the compressor 28, such a condition enables the first pressurized humidified cathode stream 52 to receive more water. To add more water into the first pressurized humidified cathode stream 52, the compressor 28 delivers the same to back to the first humidifier 22 so that more water can be added to the first pressurized humidified cathode stream 52 to generate the final pressurized humidified cathode stream 54. An outlet 44 of the first humidifier 22 delivers the final pressurized humidified cathode stream 54 to the fuel cell stack 12 to generate the electrical power. The exhaust valve 40 is fluidly coupled to the outlet 39 of the first humidifier 22 where it controls the flow of the re-circulated water either into an exhaust (e.g., out of the apparatus 10) or back into the first humidifier 22. Various humidity sensors (not shown) may be positioned along the cathode path to monitor the humidity of the cathode stream as it passes through the first humidifier 22 and onto the fuel cell stack 12.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for providing a humidified cathode fluid stream to a fuel cell stack, the apparatus comprising:
a first humidifier including membranes and configured to receive a cathode fluid stream and to humidify the cathode fluid stream with water from a recirculated fluid stream for providing a first humidified cathode stream, and
a compressor configured to:
receive the first humidified cathode stream;
provide a first pressurized humidified cathode stream; and
generate a pressure differential across the first humidifier such that the membranes are humidified with the water.

2. The apparatus of claim 1 wherein the first humidifier includes a first outlet for providing the first humidified cathode stream and the compressor includes a first inlet for directly receiving the first humidified cathode stream from the first outlet.

3. The apparatus of claim 1 further comprising a second humidifier configured to receive the first pressurized humidified cathode stream and the recirculated fluid stream and to humidify the first pressurized humidified cathode stream with the water for providing a final pressurized humidified cathode stream to the fuel cell stack.

4. The apparatus of claim 3 wherein the first humidifier and the second humidifier are each a gas to gas (G2G) humidifier.

5. The apparatus of claim 3 wherein the second humidifier is configured to receive the first pressurized humidified cathode stream at a temperature that is greater than a temperature of the first humidified cathode stream thereby enabling the second humidifier to add additional water from the recirculated fluid stream on the first pressurized humidified cathode stream to provide the final pressurized cathode stream.

6. The apparatus of claim 3 wherein the second humidifier includes a first inlet for receiving the recirculated fluid stream from the fuel cell stack and a first outlet for providing the recirculated fluid stream and the first humidifier includes a first inlet for receiving the recirculated fluid stream from the first outlet of the second humidifier.

7. The apparatus of claim 1 wherein the first humidifier includes a first inlet for receiving the cathode fluid stream, a second inlet for receiving the recirculated fluid stream, and a third inlet for receiving the first pressurized humidified cathode stream.

8. The apparatus of claim 7 wherein the first humidifier is further configured to humidify the first pressurized humidified cathode stream with the water for providing a final pressurized humidified cathode stream to the fuel cell stack.

9. The apparatus of claim 8 wherein the first humidifier is configured to receive the first pressurized humidified cathode stream at a temperature that is greater than a temperature of the first humidified cathode stream thereby enabling the second humidifier to add additional water from the recirculated fluid stream into the first pressurized humidified cathode stream to provide the final pressurized cathode stream.

10. A vehicle fuel cell system comprising:
a first humidifier configured to receive a cathode fluid stream and to add water thereto from a recirculated fluid stream to provide a first humidified cathode stream, and
a compressor configured to receive the first humidified cathode stream and to provide a pressurized humidified cathode stream, the compressor for generating a pressure differential across the first humidifier such that membranes in the first humidifier are humidified with the water.

11. The system of claim 10 wherein the first humidifier includes a first outlet for providing the first humidified cathode stream and the compressor includes a first inlet for directly receiving the first humidified cathode stream from the first outlet.

12. The system of claim 10 further comprising a second humidifier configured to receive the pressurized humidified cathode stream and the recirculated fluid stream and to humidify the pressurized humidified cathode stream with the water for providing a final pressurized humidified cathode stream to a fuel cell stack.

13. The system of claim 12 wherein the first humidifier and the second humidifier are each a gas to gas (G2G) humidifier.

14. The system of claim 12 wherein the second humidifier is configured to receive the pressurized humidified cathode stream at a temperature that is greater than a temperature of the first humidified cathode stream thereby enabling the second humidifier to add additional water from the recirculated fluid stream on the first pressurized humidified cathode stream to provide the final pressurized cathode stream.

15. The system of claim 12 wherein the second humidifier includes a first inlet for receiving the recirculated fluid stream from the fuel cell stack and a first outlet for providing the recirculated fluid stream and the first humidifier includes a first inlet for receiving the recirculated fluid stream from the first outlet of the second humidifier.

16. The system of 10 wherein the first humidifier includes a first inlet for receiving the cathode fluid stream, a second inlet for receiving the recirculated fluid stream, and a third inlet for receiving the pressurized humidified cathode stream.

17. The system of claim 16 wherein the first humidifier is further configured to humidify the pressurized humidified cathode stream with the water for providing a final pressurized humidified cathode stream to a fuel cell stack.

18. The system of claim 17 wherein the first humidifier is configured to receive the pressurized humidified cathode stream at a temperature that is greater than a temperature of the first humidified cathode stream thereby enabling the second humidifier to add additional water from the recirculated fluid stream into the pressurized humidified cathode stream to provide the final pressurized cathode stream.

19. A vehicle fuel cell system comprising:
a gas-to-gas (G2G) humidifier configured to receive a cathode fluid stream and to add water thereto from a recirculated fluid stream to provide a humidified cathode stream, and
a compressor configured to receive the humidified cathode stream and to provide a pressurized humidified cathode stream, the compressor for generating a pressure differential in the G2G humidifier such that membranes in the G2G humidifier are humidified with the water.

20. The system of claim 19 wherein the G2G humidifier includes a first outlet for providing the humidified cathode stream and the compressor includes a first inlet for directly receiving the humidified cathode stream from the first outlet.
